(19) United States
(12) Patent Application Publication
(10) Pub. No.: US 2025/0284049 A1
(43) Pub. Date: Sep. 11, 2025

(54) OPTICAL FIBER

(71) Applicant: FURUKAWA ELECTRIC CO., LTD., Tokyo (JP)

(72) Inventor: Kazunori MUKASA, Tokyo (JP)

(73) Assignee: FURUKAWA ELECTRIC CO., LTD., Tokyo (JP)

(21) Appl. No.: 19/220,396

(22) Filed: May 28, 2025

Related U.S. Application Data
(63) Continuation of application No. PCT/JP2023/043342, filed on Dec. 4, 2023.

(30) Foreign Application Priority Data
Dec. 7, 2022 (JP) 2022-195763

(51) Int. Cl. G02B 6/02; G02B 6/036

(52) U.S. Cl. CPC G02B 6/02019; G02B 6/03633

(57) ABSTRACT

An optical fiber includes: a core portion; a cladding portion surrounding an outer periphery of the core portion and having a refractive index lower than a maximum refractive index of the core portion; and a covering layer surrounding an outer periphery of the cladding portion. The core portion includes a center core having a maximum mean refractive index in the optical fiber. A relative refractive-index difference Δ1 of a maximum refractive index of the center core in relation to a mean refractive index of the cladding portion is 0.30% or more and 0.45% or less. The cladding portion has an outer diameter of 95 μm or larger and 124 μm or smaller. The covering layer includes a primary layer surrounding the outer periphery of the core portion, and a secondary layer surrounding an outer periphery of the primary layer.

This application is a continuation of International Application No. PCT/JP2023/043342, filed on Dec. 4, 2023 which claims the benefit of priority of the prior Japanese Patent Application No. 2022-195763, filed on Dec. 7, 2022, the entire contents of which are incorporated herein by reference.

### BACKGROUND

The present disclosure relates to optical fibers.

In techniques that have been disclosed, in order to obtain a small diameter optical fiber having a small outer diameter, an outer diameter of a glass optical fiber is decreased and a thickness of a covering portion is decreased in an optical fiber having the covering portion provided over the glass optical fiber having a core portion and a cladding portion (see International Publication No. WO 2016/190297, Japanese Unexamined Patent Application Publication No. 05-019144, Japanese Unexamined Patent Application Publication No. 2015-219271, P. Sillard et al., “180 μm-Coated Bend-Insensitive Fiber and Micro-Duct Cable”, ECOC 2021, Wel A.3, (2021), Tomotaka Murase et al., “Development of Small Diameter Cladding Fiber”, SWCC Showa Group Technical Review, Vol. 53, No. 1 (2003), Matsuo et al., “1,728-Fiber Cable with 12-Fiber Ribbons Comprising 160-μm Coating Fiber with 160-μm Cladding”, OFC 2021,M3C.3, (2021) and K. Mukasa et al., “Optimization of Thin Glass Diameter Fibers”, OFC 2021, M3C.1, (2021)). Furthermore, in techniques disclosed in Japanese Unexamined Patent Application Publication No. 2010-181641 and Japanese Unexamined Patent Application Publication No. 2013-242545, the mode field of the fundamental mode at a wavelength of 1310 nm is set to 8.2 μm or larger with the bending loss reduced, so that characteristics of connection to other optical fibers are improved.

### SUMMARY

Optical fibers having a glass optical fiber with an outer diameter (also called a glass diameter) of 125 μm have been the most widespread publicly known optical fibers for communication. For example, a single mode fiber (also called a standard optical fiber or a standard SMF) is one of such optical fibers, the single mode optical fiber having characteristics conforming to standards defined by ITU-T G. 652 of the International Telecommunication Union (ITU). Such a standard SMF usually has a covering layer made of resin having a thickness of about 62.5 μm over an outer periphery of a cladding portion having an outer diameter of 125 μm. For example, in a case where the covering layer has a two-layer structure, the covering layer is formed of: a primary layer having a thickness of about 37.5 μm; and a secondary layer surrounding an outer periphery of the primary layer and having a thickness of about 25 μm. Therefore, the covering layer has an outer diameter of about 250 μm. There are many processing devices for 125 μm, such as covering removing devices, cutting devices, and connecting devices, which are used when optical fibers having a glass diameter of 125 μm are cut or connected.

An optical fiber disclosed in, for example, P. Sillard et al., has a covering layer with a smaller outer diameter of 180 μm for an optical fiber having a glass diameter of 125 μm.

However, using a processing device for 125 μm for an optical fiber, to which a technique for making its glass diameter smaller than 125 μm has been applied for obtainment of a small diameter optical fiber, may make processing work, such as removal of a covering, cutting, and connection, difficult, reduce processing quality, and complicate handling.

Furthermore, there is a demand for appropriate mode field diameters to enhance characteristics of connection of small fiber optical fibers to other optical fibers. What is more, there is a demand for smaller microbending losses for small diameter optical fibers in view of cable production and laying in fields.

There is a need for an optical fiber having a small diameter, as well as good processing workability and handleability, good connection characteristics, and a low microbending loss.

According to one aspect of the present disclosure, there is provided an optical fiber including: a core portion; a cladding portion surrounding an outer periphery of the core portion and having a refractive index lower than a maximum refractive index of the core portion; and a covering layer surrounding an outer periphery of the cladding portion, wherein the core portion includes a center core having a maximum mean refractive index in the optical fiber, a relative refractive-index difference Δ1 of a maximum refractive index of the center core in relation to a mean refractive index of the cladding portion is 0.30% or more and 0.45% or less, the cladding portion has an outer diameter of 95 μm or larger and 124 μm or smaller, the covering layer includes a primary layer surrounding the outer periphery of the core portion, and a secondary layer surrounding an outer periphery of the primary layer, the primary layer has an outer diameter of 126 μm or larger, the secondary layer has an outer diameter of 179 μm or smaller, the primary layer has a thickness of 10 μm or larger, the secondary layer has a thickness of 5 μm or larger, and the optical fiber has a mode field diameter of 8.3 μm or larger and 10.0 μm or smaller of a fundamental mode at a wavelength of 1310 nm.

### BRIEF DESCRIPTION OF THE DRAWINGS

FIG. 1 is a schematic sectional view of an optical fiber according to an embodiment;

FIG. 2A is a schematic diagram of an example of a refractive index profile of the optical fiber according to the embodiment;

FIG. 2B is a schematic diagram of an example of a refractive index profile of the optical fiber according to the embodiment;

FIG. 2C is a schematic diagram of an example of a refractive index profile of the optical fiber according to the embodiment;

FIG. 3 is a diagram illustrating an example of relations between glass diameters and normalized microbending losses for various primary diameters and secondary diameters; and

FIG. 4 is a diagram illustrating an example of relations between Δ1 and normalized microbending losses for step-type, W-type, and trench-type refractive index profiles.

### DETAILED DESCRIPTION

An embodiment of the present disclosure will be described in detail hereinafter while reference is made to the appended drawings. The present disclosure is not to be limited by the embodiment described hereinafter. Furthermore, throughout the drawings, any components that are the same or corresponding to each other will be assigned with the same reference sign, as appropriate. In addition, a cutoff wavelength or an effective cutoff wavelength in this specification refers to a cable cutoff wavelength defined by ITU-T G.650.1 of the International Telecommunication Union (ITU). Furthermore, any other term not particularly defined in this specification conforms to the definitions and measurement methods according to G.650.1 and G.650.2.

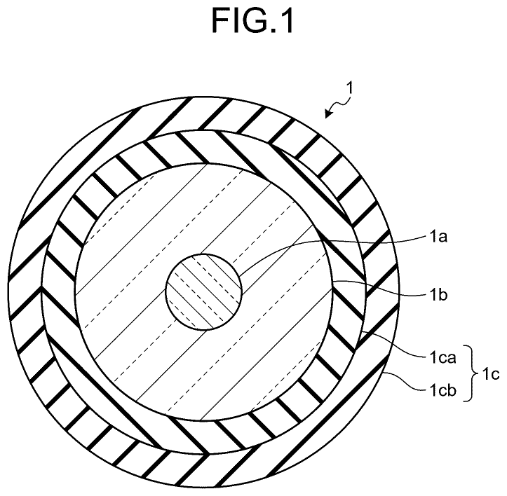

FIG. 1 is a schematic sectional view of an optical fiber according to an embodiment. An optical fiber 1 includes: a core portion 1a made of silica based glass; a cladding portion 1b made of silica-based glass that has a refractive index lower than the maximum refractive index of the core portion 1a, the cladding portion 1b surrounding an outer periphery of the core portion 1a; and a covering layer 1c surrounding an outer periphery of the cladding portion 1b. The covering layer 1c has: a primary layer 1casurrounding the outer periphery of the cladding portion 1b; and a secondary layer 1cb surrounding an outer periphery of the primary layer 1ca.

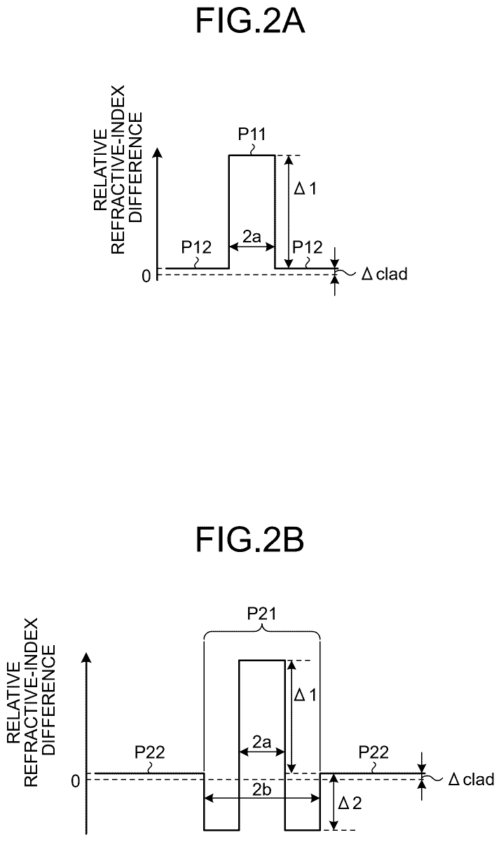

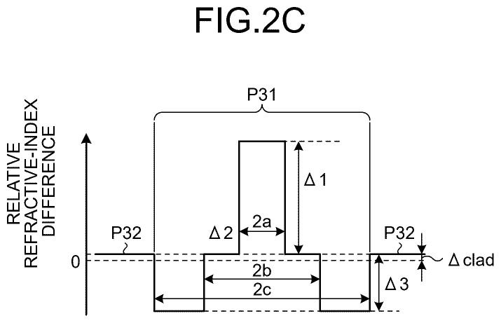

The optical fiber 1 has a refractive index profile like that illustrated in FIG. 2A, FIG. 2B, or FIG. 2C, for example. FIG. 2A to FIG. 2C all illustrate a refractive index profile in a radial direction from a central axis of the core portion 1a of the optical fiber 1. The refractive index profile is represented by relative refractive-index differences relative to pure silica glass. Pure silica glass herein refers to extremely pure silica glass substantially not including a dopant that changes its refractive index and having a refractive index of about 1.444 at a wavelength of 1550 nm.

FIG. 2A illustrates a step-type refractive index profile. In FIG. 2A, a profile P11 represents a refractive index profile of the core portion 1a and a profile P12 represents a refractive index profile of the cladding portion 1b. In the step type refractive index profile, a diameter (core diameter) of the core portion 1a is 2a and a relative refractive-index difference (maximum relative refractive-index difference) of the maximum refractive index of the core portion la in relation to a mean refractive index of the cladding portion 1b is 41. Furthermore, a relative refractive-index difference of the mean refractive index of the cladding portion 1b in relation to the refractive index of pure silica glass is ΔClad. In FIG. 2A, a center core that is a portion of the core portion 1a corresponds to the whole core portion 1a, the portion having the maximum mean refractive index in the core portion 1a.

FIG. 2B illustrates a so-called W-type refractive index profile. In FIG. 2B, a profile P21 represents a refractive index profile of the core portion 1a and a profile P22 represents a refractive index profile of the cladding portion 1b. In the W-type refractive index profile, the core portion 1a includes: a center core having a diameter of 2a; and a depressed layer formed to surround an outer periphery of the center core, having a refractive index smaller than a refractive index of the cladding portion, having an inner diameter of 2a, and having an outer diameter of 2b. The center core is a portion having the maximum mean refractive index in the core portion 1a. The maximum relative refractive-index difference of the center core in relation to the mean refractive index of the cladding portion 1b is Δ1. A relative refractive-index difference of a mean refractive index of the depressed layer in relation to the mean refractive index of the cladding portion 1b is Δ2. Furthermore, a relative refractive-index difference of the mean refractive index of the cladding portion 1b in relation to the refractive index of pure silica glass is ΔClad. The depressed layer is an example of a negative Δ core layer having a negative relative refractive-index difference in relation to the mean refractive index of the cladding portion 1b, and is an example of an inner core layer.

FIG. 2C illustrates a so-called trench-type refractive index profile. In FIG. 2C, a profile P31 represents a refractive index profile of the core portion 1a and a profile P32 represents a refractive index profile of the cladding portion 1b. In this trench-type refractive index profile, the core portion 1a includes: a center core having a diameter of 2a; an intermediate layer formed to surround an outer periphery of the center core, having a refractive index smaller than the maximum refractive index of the center core, and having an inner diameter of 2a and an outer diameter of 2b; and a trench layer formed to surround an outer periphery of the intermediate layer, having a refractive index smaller than the refractive index of the cladding portion, and having an inner diameter of 2b and an outer diameter of 2c. The center core is a portion having the maximum mean refractive index in the core portion 1a. The maximum relative refractive-index difference of the center core in relation to the mean refractive index of the cladding portion 1b is Δ1. A relative refractive-index difference of a mean refractive index of the intermediate layer in relation to the mean refractive index of the cladding portion 1b is 42. This Δ2 is usually set to 0% or around 0%. A range of Δ2 is, for example, −0.05% or more and 0.05% or less. A relative refractive-index difference of a mean refractive index of the trench layer in relation to the mean refractive index of the cladding portion 1b is Δ3. Furthermore, a relative refractive-index difference of the mean refractive index of the cladding portion 1b in relation to the refractive index of pure silica glass is ΔClad. The intermediate layer is an example of an inner core layer. The trench layer is an example of a negative Δ core layer and is an example of an outer core layer.

The refractive index profile of the core portion 1a is not limited to that of a step-type having a geometrically ideal form, and a top portion of the refractive index profile of the core portion 1a may have irregularities formed due to manufacturing characteristics without being flat, or the refractive index profile of the core portion 1a may be shaped to trail off from the top portion. In this case, the refractive index of an approximately flat region of the top portion of the refractive index profile serves as an index for determining Δ1, the approximately flat region being in a range of the core diameter 2a of the core portion 1a, the core diameter 2a being according to a manufacturing design. Even in a case where the approximately flat region is thought to be divided into plural sections or a case where defining the approximately flat region is difficult because of a continuous change, if at least any part of the core portion is in the following range of Δ1 and a difference between the maximum value and the minimum value of Δ is within a certain value ±30%, characteristics close to desired characteristics have been confirmed to be achieved and no particular problem is thereby caused, the at least any part being other than a portion where the refractive index changes drastically from an adjacent layer.

Furthermore, the mean refractive indices of the depressed layer, the intermediate layer, the trench layer, and the cladding portion 1b are each a mean value of refractive indices in the radial direction of the refractive index profile.

The following description is on material of the optical fiber 1. The center core of the core portion 1a is made of, for example, pure silica glass, or silica glass including one or more selected from a group consisting of: chlorine (Cl), fluorine (F), germanium (Ge), potassium (K), and sodium (Na). F is a dopant that lowers the refractive index of silica glass, and Ge, Cl, K, and Na are dopants that increase the refractive index of silica glass.

At least part of the cladding portion 1b on the other hand is made of silica glass including a dopant that lowers the refractive index, for example, fluorine or boron (B). However, the depressed layer and the trench layer are made of silica glass including an amount of fluorine or boron that is a dopant that lowers the refractive index, the amount being larger than that in the cladding portion. The intermediate layer is made of silica glass with a composition that is the same as or close to that of the cladding portion 1b. The dopant to lower the refractive index is preferably fluorine in terms of manufacturability.

The primary layer 1ca and the secondary layer 1cb are made of resin. This resin is, for example, ultraviolet-curable resin. The ultraviolet-curable resin is, for example, a mixture of various resin materials and additives, such as oligomers, diluent monomers, photoinitiators, silane coupling agents, intensifiers, and lubricants. The oligomers that may be used are, for example, known materials, such as polyether urethane acrylates, epoxy acrylates, polyester acrylates, and silicone acrylates. The diluent monomers that may be used are, for example, known materials, such as monofunctional monomers and multifunctional monomers. Furthermore, the additives are not limited to those mentioned above and, for example, known additives used for ultraviolet curable resins may be used widely.

An elastic modulus of the primary layer 1ca (primary elastic modulus) is, for example, 0.2 MPa or more and 3.0 MPa or less, and is further 1.0 MPa or less. An elastic modulus of the secondary layer 1cb (secondary elastic modulus) of, for example, 2000 MPa or less enables the secondary layer 1cb to have rigidity in an appropriate range. Furthermore, the secondary elastic modulus is preferably 5.0 MPa or more, and more preferably 500 MPa or more.

This optical fiber 1 is configured to have a small diameter, as well as good processing workability and handleability, good connection characteristics, and small microbending loss. Specifically, the optical fiber 1 has a relative refractive-index difference Δ1 of 0.30% or more and 0.45% or less. Furthermore, the cladding portion 1b has an outer diameter (glass diameter) of 95 μm or larger and 124 μm or smaller. Furthermore, the primary layer 1ca has an outer diameter (primary diameter) of 126 μm or larger, and the secondary layer 1cb has an outer diameter of 179 μm or smaller. Furthermore, the primary layer 1ca has a thickness (primary thickness) of 10 μm or larger, and the secondary layer 1cb has a thickness (secondary thickness) of 5 μm or larger. Furthermore, the optical fiber 1 has a mode field diameter of 8.3 μm or larger and 10.0 μm or smaller of a fundamental mode at the wavelength of 1310 nm. Furthermore, for example, the optical fiber 1 has a mode field diameter of 9.0 μm or larger and 11.0 μm or smaller at the wavelength of 1550 nm.

The optical fiber 1 will hereinafter be described more specifically. Firstly, the optical fiber 1 has a glass diameter of 95 μm or larger and 124 μm or smaller. As a result, the optical fiber 1 has a smaller diameter, processing work for the optical fiber 1 using a processing device for 125 μm is facilitated, and good processing workability and handleability are achieved.

The present inventor executed removing work for covering layers of optical fibers having various glass diameters and cutting work for their core portions and cladding portions, by using a covering removing device and a cutting device that are processing devices for 125 μm. The optical fibers that had been cut were then physically connected to standard SMFs and their connection losses were measured. This physical connection is by physical connection using, for example, a V-grooved jig, and the losses were measured by using a method called a cutback method defined by JIS C6823:2010.

Table 1 illustrates an example of relations between glass diameters and success rates of connection, for optical fibers. For Table 1, a connection loss of 0.5 dB or less has been determined as a success. As evident from Table 1, a glass diameter of 95 μm or larger results in a success rate of 72% or more and stable good connection characteristics. Furthermore, it was confirmed that a glass diameter larger than 101 μm results in a higher success rate and a glass diameter of 105 μm or larger results in an even higher success rate. Cut edges resulting from cutting of optical fibers high in connection loss were slanted and/or planes of these sections were chipped. However, in terms of reducing diameters of optical fibers, the glass diameter is preferably 124 μm or smaller, more preferably 122 μm or smaller, and even more preferably 120 μm or smaller.

TABLE 1

| Glass | | | | | | | | | | | | |
|---|---|---|---|---|---|---|---|---|---|---|---|---|
| diameter | | | | | | | | | | | | |
| [μm] | 70 | 75 | 80 | 85 | 90 | 95 | 100 | 105 | 110 | 115 | 120 | 125 |
| Success | 4 | 12 | 21 | 33 | 46 | 72 | 80 | 86 | 92 | 96 | 98 | 99 |
| rate [%] | | | | | | | | | | | | |

Processing conditions of processing devices for 125 μm may sometimes be finely adjusted or finely changed, and even if the glass diameter is not 125 μm, the processing conditions may sometimes be changed to those more suitable for that glass diameter. A fine adjustment or a fine change of a processing condition is, for example, a fine adjustment of tension applied to the optical fiber in a covering removing device. However, trends in Table 1 are considered to be unchanged even if such a fine adjustment or a fine change is made.

As to the mode field diameter of the optical fiber 1 next, a mode field diameter of 8.3 μm or larger and 10.0 μm or smaller of the fundamental mode at the wavelength of 1310 nm enables reduction of loss in connection to a standard SMF and thus achieves good connection characteristics. Furthermore, such a range of the mode field diameter is preferable in terms of minimizing non-linear optical phenomena in transmission of signal light. Similarly, as to the mode field diameter of the optical fiber 1, the mode field diameter at the wavelength of 1550nm is preferably 9.0 μm or larger and 11.0 μm or smaller. Furthermore, more preferably, the mode field diameter of the fundamental mode at the wavelength of 1310 nm is 8.4 μm or larger and the mode field diameter at the wavelength of 1550 nm is 9.2 μm or larger. Furthermore, the mode field diameter of the fundamental mode at the wavelength of 1310 nm is even more preferably 8.6 μm or larger.

However, reducing the glass diameter of an optical fiber and increasing the mode field diameter tend to increase microbending loss (also called lateral pressure loss) of the optical fiber. Furthermore, setting of the thickness of the covering layer of an optical fiber also influences the microbending loss. For example, excessively reducing the thickness of a covering layer tends to increase the microbending loss.

Furthermore, the transmission loss in an optical fiber usually increases in a state where the optical fiber has been formed into an optical fiber cable. The amount of increase in the transmission loss then is closely related to the microbending loss, and the larger the microbending loss, the larger the amount of increase.

A practical microbending loss in the optical fiber 1 is 10 times or less the microbending loss of a standard SMF at the wavelength of 1550 nm. If a value resulting from normalization of a microbending loss with the microbending loss of a standard SMF is defined as a normalized microbending loss, the optical fiber 1 preferably has a normalized microbending loss of 10 or less. Furthermore, the normalized microbending loss in the optical fiber 1 is more preferably 5 or less.

A value measured by a sandpaper method similar to a fixed diameter drum method prescribed by JIS C6823:2010 may be adopted as a microbending loss. In the sandpaper method, for example, a difference between a transmission loss in a state A and a transmission loss of an optical fiber in a state B is defined as a value of microbending loss, the state A being where the optical fiber having a length of 500 m has been wound at a tension of 100 gf, in a single layer without overlap between windings, around a fixed drum having number #1000 sandpaper wound around the fixed drum, the state B being where the optical fiber is wound, at the same tension and same length as the state A, around a bobbin that would be the same as that in the state A without the sandpaper wound therearound. The transmission loss of the optical fiber in the state B is considered to be a transmission loss specific to the optical fiber itself, without including any microbending loss. Furthermore, in this measurement method, the transmission loss is measured at a wavelength of, for example, 1550 nm, and the microbending loss is thus also a value at the wavelength of 1550 nm. Any microbending loss mentioned hereinafter is a value at the wavelength of 1550 nm unless particularly stated otherwise.

The present inventor systematically conducted research on values of normalized microbending loss of optical fibers designed to have refractive index profiles resulting in mode field diameters of 8.3 μm or larger of the fundamental mode at the wavelength of 1310 nm and designed to have various glass diameters, primary diameters, and secondary diameters. As a result, it has been found, for all of the refractive index profiles, that the glass diameter and primary diameter dominantly influence the microbending loss and the secondary diameter has a small influence on the microbending loss.

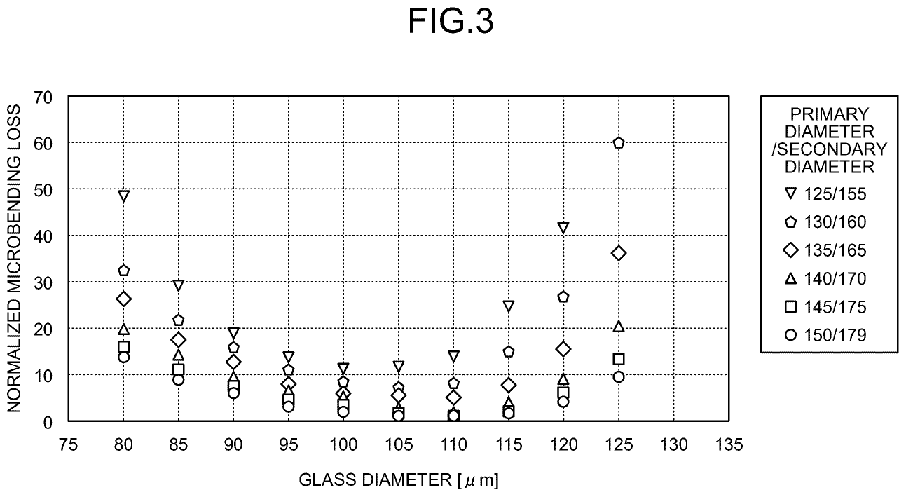

FIG. 3 is a diagram illustrating an example of relations between glass diameters and normalized microbending losses for various primary diameters and secondary diameters. A value of an optical fiber having the lowest value of normalized microbending loss is adopted in FIG. 3 as a normalized microbending loss of an optical fiber having a certain glass diameter, the optical fiber being among optical fibers having various refractive index profiles resulting in a mode field diameter of 8.3 μm of the fundamental mode at the wavelength of 1310 nm. Furthermore, the secondary thickness was set to 15 μm.

As illustrated in FIG. 3, it has been found that the glass diameters are closely related to the primary diameters and microbending losses. Furthermore, the systematic research by the present inventor confirmed that in a case where the mode field diameter of the fundamental mode at the wavelength of 1310 nm is larger than 8.3 μm, the value of the normalized microbending loss is increased, but the shape of the graph in that case is similar to the shape illustrated in FIG. 3.

The systematic research by the present inventor, the systematic research including the results in FIG. 3, confirmed that if the glass diameter is 95 μm or larger and 124 μm or smaller and the primary diameter is 126 μm or larger, the mode field diameter of the fundamental mode at the wavelength of 1310 nm is able to be made 8.3 μm, the secondary diameter, that is, the outer diameter of the covering portion (covering diameter) is able to be reduced to 179 μm or smaller, and the normalized microbending loss is able to be made 10 or less. Furthermore, the primary diameter is preferably 150 μm or smaller for reducing the diameter.

Furthermore, the secondary diameter is preferably 160 μm or larger for reducing the normalized microbending loss to 10 or less and is preferably 175 μm or less for reducing the diameter.

Furthermore, the primary thickness was confirmed to be preferably 10 μm or larger for reducing the normalized microbending loss to 10 or less, and more preferably 12.5 μm or larger.

Furthermore, the secondary thickness is preferably 5 um or larger, more preferably 10 μm or larger, and even more preferably 12.5 μm or larger, for adequate mechanical strength of the optical fiber 1 and ease of the drawing process in the manufacture.

Furthermore, for stably achieving a lower microbending loss or for a larger mode field diameter of 8.4 μm or larger or 8.6 μm or larger of the fundamental mode at the wavelength of 1310 nm, the glass diameter is preferably larger than 101 μm and equal to or smaller than 122 μm and more preferably 105 μm or larger and 120 μm or smaller, and the primary diameter is preferably 135 μm or larger.

In view of the above, an example of particularly preferable ranges for characteristics of the optical fiber 1 are a mode field diameter of 8.6 μm or larger of the fundamental mode at the wavelength of 1310 nm, a glass diameter of 105 μm or larger and 120 μm or smaller, and a secondary diameter of 160 μm or larger and 175 μm or smaller.

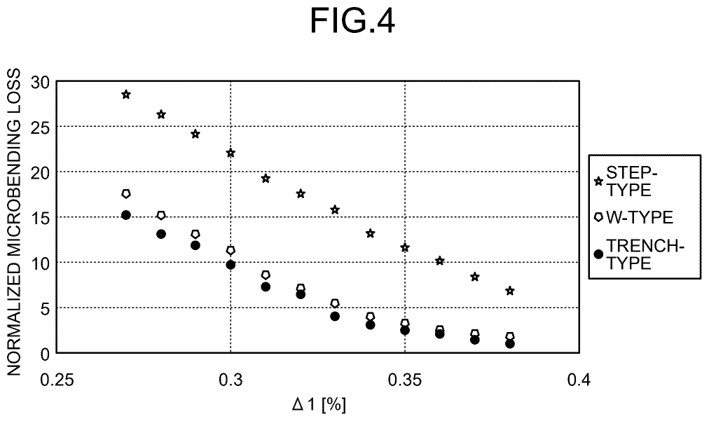

Of results of the research by the present inventor, relations between Δ1 and normalized microbending losses will be described next. FIG. 4 is a diagram illustrating an example of relations between Δ1 and normalized microbending losses, for step-type, W-type, and trench-type refractive index profiles. A value of an optical fiber having the lowest value of normalized microbending loss is adopted in FIG. 4 as a normalized microbending loss, the optical fiber being among optical fibers designed to have refractive index profiles resulting in a mode field diameter of 8.6 μm of the fundamental mode at the wavelength of 1310 nm, the optical fibers having a glass diameter of 110 μm, a primary diameter of 140 μm, and a secondary diameter of 165 μm.

As illustrated in FIG. 4, when Δ1 is less than 0.3%, even if a W-type or trench-type refractive index profile is adopted, it is difficult to achieve a normalized microbending loss of 10 or less. Furthermore, results of the research by the present inventor also confirmed that when Δ1 is larger than 0.45%, it is difficult for the mode field diameter to be 8.3 μm or larger, the mode field diameter being of the fundamental mode at the wavelength of 1310 nm. Therefore, Δ1 is preferably 0.30% or more and 0.45% or less to achieve an adequate mode field diameter and a good microbending loss characteristic.

Furthermore, from results of the research by the present inventor, it was found that the minimum value of relative refractive-index difference of a negative Δ core layer, such as a depressed layer for a W-type refractive index profile or a trench layer for a trench-type refractive index profile, is preferably −0.26% or more and −0.05% or less to achieve an adequate mode field diameter and a good microbending loss characteristic.

Furthermore, the optical fiber 1 preferably has a cable cutoff wavelength of 1530 nm or shorter to enable single-mode transmission of signal light of the wavelength of 1550 nm. Furthermore, the optical fiber 1 preferably has a cable cutoff wavelength of 1260 nm or shorter to enable single-mode transmission of signal light of the wavelength of 1310 nm.

The optical fiber 1 according to the embodiment may be manufactured easily by: manufacturing an optical fiber preform by a publicly known method using, for example, the vapor axial deposition (VAD) method, the outside vapor deposition (OVD) method, the modified chemical vapor deposition (MCVD) method, or the plasma CVD method; and drawing the optical fiber 1 from this optical fiber preform.

For example, a dopant, such as germanium, fluorine, potassium, or sodium, may be added in the optical fiber preform by use of gas including the dopant when soot is synthesized. Furthermore, doping with potassium or sodium may be performed by a gas phase method or an immersion method for glass by utilizing the fast diffusion of potassium or sodium, instead of upon synthesization of soot. Furthermore, chlorine may be added to the optical fiber preform by causing chlorine gas to remain, the chlorine gas being used in a dehydration process. In addition, fluorine may be added to the optical fiber preform by causing fluorine gas to flow in vitrification sintering formation.

In examples of the present disclosure, optical fibers of Sample Nos. 1 to 23 were drawn from optical fiber preforms manufactured using the VAD method and their optical characteristics were measured. A covering layer including a primary layer and a secondary layer and made of ultraviolet-curable resin was formed in each optical fiber. The primary layers had an elastic modulus of 0.4 MPa and the secondary layers had an elastic modulus of 1000 MPa.

Tables 2-1 and 2-2 have, listed therein, configurations and optical characteristics of the optical fibers of Sample Nos. 1 to 23. In Table 2-2, “λcc” means cable cutoff wavelength.

The optical fibers of Sample Nos. 1 to 7 each have a step-type refractive index profile. The optical fibers of Sample Nos. 8 to 10 each have a W-type refractive index profile. The optical fibers of Sample Nos. 11 to 23 each have a trench-type refractive index profile.

Furthermore, the optical fibers of Sample Nos. 1 to 23 each have Δ1 of 0.33% or more and 0.42% or less (specifically, Δ1 is 0.33%, 0.34%, 0.35%, 0.36%, 0.37%, 0.38%, 0.39%, 0.40% and 0.42%). Furthermore, their center cores each have a diameter 2a of 7.8 μm or larger and 10.5 μm or smaller (specifically, 2a is 7.8 μm, 7.9 μm, 8.0 μm, 8.1 μm, 8.2 μm, 8.3 μm, 8.4 μm, 8.5 μm, 8.7 μm, 9.0 μm, and 10.0 μm). Furthermore, the optical fibers of Sample Nos. 8 to 23 each having a W-type or trench-type refractive index profile each have Δ1 of 0.39% or less and their center cores each have a diameter 2a of 7.8 μm or larger and 10.5 μm or smaller.

Furthermore, the optical fibers of Sample Nos. 8 to 23 each having a W-type or trench-type refractive index profile each have b/a of 1.9 or more and 4.0 or less (specifically, b/a is 1.9, 2.2, 3.0, 3.4, 3.6, 3.9, and 4.0). They each have c/a of 3.5 or more and 5.0 or less (specifically, c/a is 3.5, 3.9, 4.0, and 5.0).

The optical fibers listed in Tables 2-1 and 2-2 all had a glass diameter of 95 μm or larger and 124 μm or smaller (specifically, their glass diameters were 100 μm, 102 μm, 103 μm, 105 μm, 107 μm, 108 μm, 110 μm, 112 μm, 113 μm, 114 μm, 115 μm, 116 μm, 118 μm, 119 μm, 121 μm, 122 μm, and 124 μm). Of the covering diameters, the primary diameters were 126 μm or larger and the secondary diameters were 179 μm or smaller (specifically, the primary diameters were 126 μm, 128 μm, 129 μm, 130 μm, 131 μm, 132 μm, 133 um, 134 μm, 135 μm, 136 μm, 139 μm, 141 μm, 142 μm, 143 μm, 144 pm, 146 μm, 147 μm, and 149 μm, and the secondary diameters were 159 μm, 160 μm, 161 μm, 162 μm, 163 μm, 165 um, 166 μm, 168 μm, 170 μm, 171 μm, 172 μm, 173 μm, 175 μm, 177 μm, and 179 μm). Furthermore, the normalized microbending losses were 10 or less (specifically, the normalized microbending losses were 3.9, 4.1, 5.3, 5.4, 5.6, 5.7, 5.8, 6.0, 6.3, 6.4, 6.6, 6.7, 7.7, 8.1, 8.5, 8.7, 9.2, and 9.3). Furthermore, the mode field diameters of the fundamental mode at the wavelength of 1310 nm were 8.3 μm or larger (specifically, the mode field diameters were 8.47 μm, 8.57 μm, 8.60 μm, 8.61 μm, 8.71 μm, 8.72 μm, 8.73 μm, 8.77 μm, 8.79 μm, 8.80 μm, 8.87 μm, 8.90 μm, 8.91 μm, 8.95 μm, 9.03 μm, 9.05 μm, 9.09 μm, 9.11 μm, 9.22 μm, 9.39 μm, 9.48 μm, 9.50 μm, and 9.66 μm).

Furthermore, the optical fibers listed in Table 2 all had λcc of 1530 nm or shorter (specifically, λcc was 1157 nm, 1185 nm, 1234 nm, 1241 nm, 1246 nm, 1250 nm, 1251 nm, 1254 nm, 1255 nm, 1256 nm, 1258 nm, 1259 nm, 1279 nm, 1328 nm, 1340 nm, 1360 nm, 1419 nm, and 1421 nm).

TABLE 2-1

| | Δ1 | Δ2 | Δ3 | | | 2a |
|---|---|---|---|---|---|---|
| | [%] | [%] | [%] | b/a | c/a | [μm] |
| No. 1 | 0.33 | | | | | 9.0 |
| No. 2 | 0.35 | | | | | 10.0 |
| No. 3 | 0.36 | | | | | 9.0 |
| No. 4 | 0.37 | | | | | 9.0 |
| No. 5 | 0.38 | | | | | 10.0 |
| No. 6 | 0.40 | | | | | 8.0 |
| No. 7 | 0.42 | | | | | 9.0 |
| No. 8 | 0.36 | −0.07 | | 3.9 | | 10.5 |
| No. 9 | 0.37 | −0.10 | | 4.0 | | 9.2 |
| No. 10 | 0.38 | −0.08 | | 3.6 | | 9.7 |
| No. 11 | 0.37 | −0.05 | −0.20 | 3.0 | 4.0 | 8.7 |
| No. 12 | 0.35 | 0 | −0.20 | 2.2 | 4.0 | 8.5 |
| No. 13 | 0.39 | 0 | −0.20 | 2.2 | 4.0 | 8.1 |
| No. 14 | 0.37 | 0.04 | −0.20 | 2.2 | 4.0 | 7.9 |
| No. 15 | 0.37 | 0 | −0.16 | 2.2 | 4.0 | 8.4 |
| No. 16 | 0.37 | 0 | −0.26 | 2.2 | 4.0 | 8.1 |
| No. 17 | 0.34 | 0 | −0.20 | 3.0 | 5.0 | 8.2 |
| No. 18 | 0.38 | 0 | −0.20 | 3.0 | 5.0 | 7.8 |
| No. 19 | 0.37 | 0 | −0.20 | 3.4 | 5.0 | 8.1 |
| No. 20 | 0.37 | 0 | −0.20 | 1.9 | 3.9 | 8.3 |
| No. 21 | 0.37 | 0 | −0.12 | 3.0 | 5.0 | 8.2 |
| No. 22 | 0.37 | 0 | −0.20 | 2.2 | 3.5 | 8.5 |
| No. 23 | 0.39 | 0 | −0.20 | 3.0 | 5.0 | 7.9 |

TABLE 2-2

| | | Covering | Normalized | MFD | |
|---|---|---|---|---|---|
| | | diameter | micro- | (Fundamental | |
| | Glass | Primary/ | bending | mode) | |
| | diameter | secondary | loss | 1310 nm | λcc |
| | [μm] | [μm] | 1550 nm | [μm] | [nm] |
| No. 1 | 122 | 149/179 | 8.7 | 9.39 | 1185 |
| No. 2 | 119 | 146/177 | 8.5 | 9.66 | 1360 |
| No. 3 | 116 | 143/175 | 8.1 | 9.22 | 1241 |
| No. 4 | 115 | 141/173 | 7.7 | 9.11 | 1254 |
| No. 5 | 113 | 139/171 | 9.2 | 9.48 | 1419 |
| No. 6 | 110 | 135/168 | 6.3 | 8.47 | 1157 |
| No. 7 | 108 | 133/166 | 6.6 | 8.77 | 1340 |
| No. 8 | 114 | 142/170 | 6.9 | 9.50 | 1421 |
| No. 9 | 105 | 135/165 | 6.0 | 8.79 | 1234 |
| No. 10 | 100 | 130/162 | 6.4 | 9.03 | 1328 |
| No. 11 | 124 | 150/179 | 4.1 | 8.71 | 1246 |
| No. 12 | 121 | 147/175 | 5.4 | 9.05 | 1255 |
| No. 13 | 118 | 144/173 | 3.9 | 8.60 | 1255 |
| No. 14 | 115 | 141/171 | 6.6 | 8.95 | 1246 |
| No. 15 | 112 | 139/170 | 5.3 | 8.87 | 1256 |
| No. 16 | 110 | 136/168 | 5.7 | 8.72 | 1251 |
| No. 17 | 108 | 134/166 | 7.7 | 9.09 | 1259 |
| No. 18 | 107 | 132/163 | 5.6 | 8.61 | 1254 |
| No. 19 | 105 | 131/162 | 5.7 | 8.80 | 1259 |
| No. 20 | 103 | 129/161 | 5.8 | 8.73 | 1250 |
| No. 21 | 102 | 128/160 | 6.7 | 8.91 | 1254 |
| No. 22 | 102 | 126/159 | 6.6 | 8.90 | 1258 |
| No. 23 | 121 | 141/172 | 9.3 | 8.57 | 1279 |

With respect to the embodiment and examples, W-type and trench-type refractive index profiles having negative Δ core layers have been described above, but a refractive index profile having a negative Δ core layer is not limited to a W-type or trench-type refractive index profile. As described above, the present disclosure may be suitably used in, for example, an optical fiber provided with a covering layer.

The present disclosure enables provision of an optical fiber having a small diameter, as well as good processing workability and handleability, good connection characteristics, and a low microbending loss.

Furthermore, the present disclosure is not to be limited by the above-described embodiment. Those configured by combination of the components described above as appropriate are also included in the present disclosure. In addition, further effects and modifications may be easily derived by those skilled in the art. Therefore, wider aspects of the present disclosure are not limited to the above-described embodiment, and various modifications may be made.

What is claimed is:

1. An optical fiber comprising:
a core portion;
a cladding portion surrounding an outer periphery of the core portion and having a refractive index lower than a maximum refractive index of the core portion; and
a covering layer surrounding an outer periphery of the cladding portion, wherein
the core portion includes a center core having a maximum mean refractive index in the optical fiber,
a relative refractive-index difference Δ1 of a maximum refractive index of the center core in relation to a mean refractive index of the cladding portion is 0.30% or more and 0.45% or less,
the cladding portion has an outer diameter of 95 μm or larger and 124 μm or smaller,
the covering layer includes a primary layer surrounding the outer periphery of the core portion, and a secondary layer surrounding an outer periphery of the primary layer,
the primary layer has an outer diameter of 126 μm or larger,
the secondary layer has an outer diameter of 179 μm or smaller,
the primary layer has a thickness of 10 μm or larger,
the secondary layer has a thickness of 5 μm or larger, and
the optical fiber has a mode field diameter of 8.3 μm or larger and 10.0 μm or smaller of a fundamental mode at a wavelength of 1310 nm.

2. The optical fiber according to claim 1, wherein the optical fiber has a mode field diameter of 9.0 μm or larger and 11.0 μm or smaller at a wavelength of 1550 nm.

3. The optical fiber according to claim 1, wherein
the outer diameter of the cladding portion is larger than 101 μm and equal to or smaller than 122 μm,
the outer diameter of the secondary layer is 160 μm or larger, and
the thickness of the secondary layer is 10 μm or larger.

4. The optical fiber according to claim 1, wherein
the outer diameter of the cladding portion is 105 μm or larger and 120 μm or smaller,
the outer diameter of the primary layer is 135 μm or larger,
the outer diameter of the secondary layer is 160 μm or larger and 175 μm or smaller, and
the thickness of the secondary layer is 12.5 μm or larger.

5. The optical fiber according to claim 1, wherein
the mode field diameter of the fundamental mode at the wavelength of 1310 nm is 8.4 μm or larger, and
the optical fiber has a mode field diameter of 9.2 μm or larger and 11.0 μm or smaller at a wavelength of 1550 nm.

6. The optical fiber according to claim 1, wherein
the optical fiber has a cable cutoff wavelength of 1530 nm or shorter, and
the mode field diameter of the fundamental mode at the wavelength of 1310 nm is 8.6 μm or larger.

7. The optical fiber according to claim 1, wherein the optical fiber has a normalized microbending loss of 10 or less at a wavelength of 1550 nm, the normalized microbending loss having been normalized with a microbending loss of a standard optical fiber at the wavelength of 1550 nm, the standard optical fiber having characteristics conforming to standards defined by ITU-T G.652, the standard optical fiber having a covering layer with a thickness of 62.5 μm, the covering layer being on an outer periphery of a cladding portion having an outer diameter of 125 μm.

8. The optical fiber according to 7, wherein the microbending loss is a value measured by a sandpaper method.

9. The optical fiber according to claim 1, wherein the Δ1 is 0.33% or more and 0.42% or less, and the center core has a diameter of 7.8 μm or larger and 10.5 μm or smaller.

10. The optical fiber according to claim 1, wherein the Δ1 is 0.33% or more and 0.39% or less, and the center core has a diameter of 7.8 μm or larger and 10.5 μm or smaller.

11. The optical fiber according to claim 1, wherein the core portion has a negative Δ core layer surrounding an outer periphery of the center core and having a negative relative refractive-index difference in relation to the mean refractive index of the cladding portion.

12. The optical fiber according to claim 11, wherein a minimum value of the relative refractive-index difference of the negative Δ core layer is −0.26% or more and −0.05% or less.

13. The optical fiber according to claim 11, wherein
the core portion has an inner core layer surrounding the outer periphery of the center core, and
b/a is 1.9 or more and 4.0 or less when the center core has a diameter of 2a and the inner core layer has an outer diameter of 2b.

14. The optical fiber according to claim 13, wherein the inner core layer is the negative Δ core layer.

15. The optical fiber according to claim 14, wherein the optical fiber has a W-type refractive index profile.

16. The optical fiber according to claim 13, wherein
the core portion has an outer core layer surrounding an outer periphery of the inner core layer, and
c/a is 3.5 or more and 5.0 or less when the outer core layer has an outer diameter of 2c.

17. The optical fiber according to claim 16, wherein the outer core layer is the negative Δ core layer.

18. The optical fiber according to claim 17, wherein the optical fiber has a trench-type refractive index profile.

19. The optical fiber according to claim 1, wherein
the primary layer has an elastic modulus of 0.2 MPa or more and 3.0 MPa or less, and
the secondary layer has an elastic modulus of 5.0 MPa or more and 2000 MPa or less.

20. The optical fiber according to claim 1, wherein in a case where removing work for the covering layer and cutting work for the core portion and the cladding portion are executed by use of a covering removing device for 125 μm and a cutting device for 125 μm and the optical fiber is physically connected to an optical fiber having characteristics conforming to standards defined by ITU-T G.652, a probability of a connection loss being 0.5 dB or less is 72% or more.
